(19) United States
(12) Patent Application Publication
(10) Pub. No.: US 2011/0078050 A1
(43) Pub. Date: Mar. 31, 2011

(54) SYSTEMS AND METHODS FOR FACILITATING CHARITABLE DONATIONS

(76) Inventor: Steven G. Schwartz, Portland, OR (US)

(21) Appl. No.: 12/890,402

(22) Filed: Sep. 24, 2010

Related U.S. Application Data
(60) Provisional application No. 61/245,873, filed on Sep. 25, 2009.

(51) Int. Cl. G06Q 99/00; G06Q 90/00; G06Q 30/00; G06F 3/01

(52) U.S. Cl. 705/27.1; 705/500; 705/329; 705/1.1; 715/733

(57) ABSTRACT

Systems and methods to facilitate charitable giving are disclosed. Exemplary embodiments of the disclosed systems and methods include an online system for selling perishable inventory to charitable donors in connection with a donation. An integrated real to virtual golf game using actual golf results, and an integrated golf virtual tee are also disclosed.

### CROSS REFERENCE TO RELATED APPLICATIONS

This nonprovisional patent application claims the priority benefit of provisional U.S. Patent Application Ser. No. 61/245,873, filed on Sep. 25, 2009, titled “Method of Soliciting Charitable Donations Through Reductions in Fixed Prices,” which is hereby incorporated by reference in its entirety.

### BACKGROUND OF THE INVENTION

1. Field of the Invention

The present invention relates generally to charitable donation systems and methods. The present invention relates more particularly to systems and methods to facilitate charitable donations through recreational golf activities.

2. Background

Approximately 1.5 million registered 501(c) nonprofit organizations (including 377,000 religious congregations) exist in the United States, with a combined annual budget requirement of $1.3 trillion. Annual contributions to charities and non-profits in the United States exceed $300 billion. An estimated 26 million golfers in the United States play about 500 million rounds at 16,000 courses, annually, making golf a $76 billion per year industry. The relationship between golfers and charities is well established and is evidenced by the significant number of charity-based golf events worldwide.

Generally, when a player wishes to play a round of golf, he or she will reserve a tee time in advance at a course of his or her selection. Only 49% of all available tee times in the U.S. are utilized. The recreational golf industry, like many other reservation-based industries, has adopted Internet-based online reservation systems in order to facilitate the efficient allocation of available tee times among interested players. In 2008, an estimated 20 million tee times at American courses were reserved via online tee time reservations systems.

Computer-based gaming has been a huge industry for many years, with golf-themed games comprising some of the most popular titles. The advent of online gaming allows the participation of geographically remote players. Online competitions that fuse elements of real life competition with a virtual experience, such as fantasy football, have also become wildly popular.

### SUMMARY OF THE INVENTION

Systems and methods of the present invention provide integrated, multichannel systems and methods for facilitating charitable donations. Although some embodiments of the present invention are directed to the golf industry, the systems and methods disclosed herein may be used in the context of any industry involving perishable inventories and/or geographically remote participants.

Exemplary embodiments of the present invention include at least three integrated components. One component of the present invention is an online reservation and charitable donation processing system and associated method. Some embodiments of the online reservation and charitable donation processing system are adapted for offering discounted golf tee times (“discount with donation system”). Another component of the present invention is an online reality-based virtual golf match and tournament system and method (“real to virtual golf game”). A further component of the present invention includes a virtual golf tee with a message contained within, e.g. offering golf-related brand promotions (“virtual golf tee”).

Various embodiments of the present discount with donation system are hosted on a website (“discount with donation website”). Golfers, courses, sponsors, and charities (collectively, “registered users”) may all register as participants with the discount with donation system using the discount with donation website. The discount with donation website may have an interface by which golfers may search for and reserve tee times at special discounted charity green fee rates, and an interface by which golfers may search for and donate to a charitable cause. Embodiments of the present discount with donation website may provide access to tee times with special promotional incentives from sponsors, and may provide information such as charity descriptions and featured promotions. Embodiments of the discount with donation website may catalog all registrants in a database.

In various embodiments, sponsors may register with the discount with donation website and engage in associated sponsorship and promotion activities, for example by offering matching charitable donations, creating events, and sponsoring events. Sponsors may create product promotions, for example to provide “points,” products, or services to benefit golfers according to tee times reserved.

In some embodiments of the discount with donation system, golf courses or tee time reservation networks may sign up with the discount with donation website to offer tee time reservations to an operator of the website for resale. In various embodiments, golf courses or tee time networks may offer tee times for listing on the discount with donation website at a reduced rate, for example in exchange for the exposure, promotion, or marketing value that may be realized for tax purposes or for another purpose. Charities may sign up as member charities and create custom web pages, for example using templates.

Embodiments of the present invention include novel methods for facilitating charitable donations in connection with the sale of goods or services. Although some embodiments of the present method are directed to methods of facilitating charitable donations in connection with the reservation of golf tee times, the inventive method may be used to facilitate charitable donations in the context of any industry involving perishable or discounted inventories.

In some embodiments of the present method, an operator of a discount with donation website may secure tee times, such as several thousands of tee times at courses in one or more locations around the region, country, or world. For example, an operator may reserve “last minute” tee times for a first rate, reduced from the normal rate, either directly from golf courses, or in some embodiments, from a tee time “clearinghouse” network. The operator may then offer the reserved tee times for sale to golfers, for example on the discount with donation website. The reserved tee times may be offered at a second rate, such as a special charity retail rate. Golfers may be offered the second rate in connection with making a charitable donation to a selected charity, for example through the discount with donation website. According to some embodiments of the present method, the operator may allow golfers to select a charity of their liking to benefit from the donation. In turn, the operator may provide the golfer's charitable donation directly to the selected charity.

A further component of the present invention is an Internet-based real to virtual golf game that incorporates the results of actual rounds of golf played by participants with virtual competition playing for virtual prizes. In various embodiments, registered users of the discount with donation website may elect to play the virtual golf game and create a player profile. Players may then invite other golfers to join them in a virtual golf pair, threesome or foursome, team or tournament. For example, a player may locate, using social networking tools, another golfer anywhere in the world to engage virtually in a golf competition. After registering for an event and inviting other golfers, each golfer in the virtual game may play an actual round of golf. Different formats may be supported, such as Four Ball, Scramble, Stroke Play, Chapman, Foursomes, or others.

After playing a round of golf, the players may post their scores to the virtual golf game website for scoring, and in some embodiments, may include written descriptions or blogs describing their round. In some embodiments, the players may take and post pictures or videos of their rounds as they play or afterward. In some embodiments, the virtual golf game website may calculate scores according to the event format and posts results including player and team rankings. In various embodiments, prizes may be provided by corporate sponsors or obtained through third parties in exchange for promotional consideration. Exemplary prizes may include golf products, travel products and discount vouchers.

Another component of the present invention is a virtual golf tee game. In embodiments of the virtual golf tee component, it incorporates the image of a golf tee that when “broken open” presents an image of a paper message coming out of the golf tee like a fortune cookie. The virtual tee message may be a joke or be promotional, coded, informational, or redeemable for goods or services. In various embodiments, the virtual tee message directs its finder to access a discount with donation website to decode the message, receive a further message, answer a riddle or trivia question, or receive a promotion, sweepstakes or contest entry, prize, or invitation.

### BRIEF DESCRIPTION OF THE DRAWINGS

FIGS. 1-7 are screenshots of exemplary user interfaces in accordance with embodiments of the present invention.

FIG. 8 is a block flow diagram of an exemplary method in accordance with embodiments of the present invention.

FIGS. 9-12 are screenshots of exemplary user interfaces in accordance with embodiments of the present invention.

FIGS. 13-16 are scorecards of exemplary systems and methods in accordance with embodiments of the present invention.

FIG. 17 is a screenshot of an exemplary result reporting interface.

FIGS. 18-20 illustrate a virtual tee.

FIG. 21 is an exemplary hardware system supporting the systems and methods disclosed herein.

### DETAILED DESCRIPTION

In various embodiments, golfers, charities, and sponsors may register online for participation in a “discount with donation” system via a website. As a part of the registration, golfers, charities, and sponsors may create an account and a profile. In various embodiments, the discount with donation system may save the account and profile information for registered users in a discount with donation system database.

Embodiments of the present discount with donation website may provide various functionalities to users. The discount with donation website may provide functionality for golfers to log in to their account, as well as to search for and reserve a tee time at a suitable course. For example, in some embodiments, the discount with donation website may provide the ability to search for tee time availability at a particular golf course, or to search by desired green fee amount. Additional search functionality may include searching for charities, sponsoring companies, golfers, donors, matching donors, featured events or tournaments, promotions, special deals, event registration capabilities, etc. In various embodiments, functionality for reserving a selected tee time and paying for the tee time are also provided. Functionality for making a donation to a selected charity may also be provided. In various embodiments, the functionality for paying for a tee time or event registration and donating to a charity may be provided by manual billing, credit card processing, electronic check processing, PayPal®, donation credits, affinity card points, or another electronic payment mechanism as is known in the electronic commerce arts.

It should be recognized that in various embodiments, the method allows people remote from each other to compete in various activities. While the bulk of the disclosure herein is made with reference to a golf game, the method for allowing remote competition may be extended to any activity chosen by the participants. The activity may be for example a sport, a game, or an activity defined by the participants.

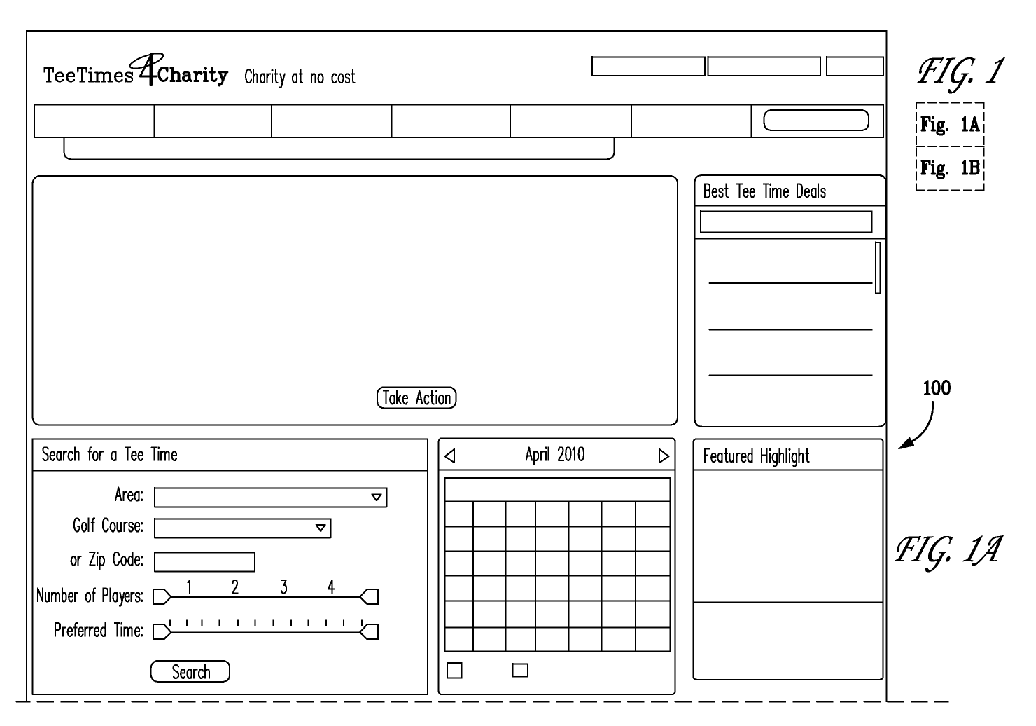

FIG. 1 illustrates an exemplary discount with donation website 100, according to the present technology. Golfers, charities, and sponsors may register and create an account and profile on the discount with donation web page. The figures that follow illustrate elements of discount with donation website 100 in further detail.

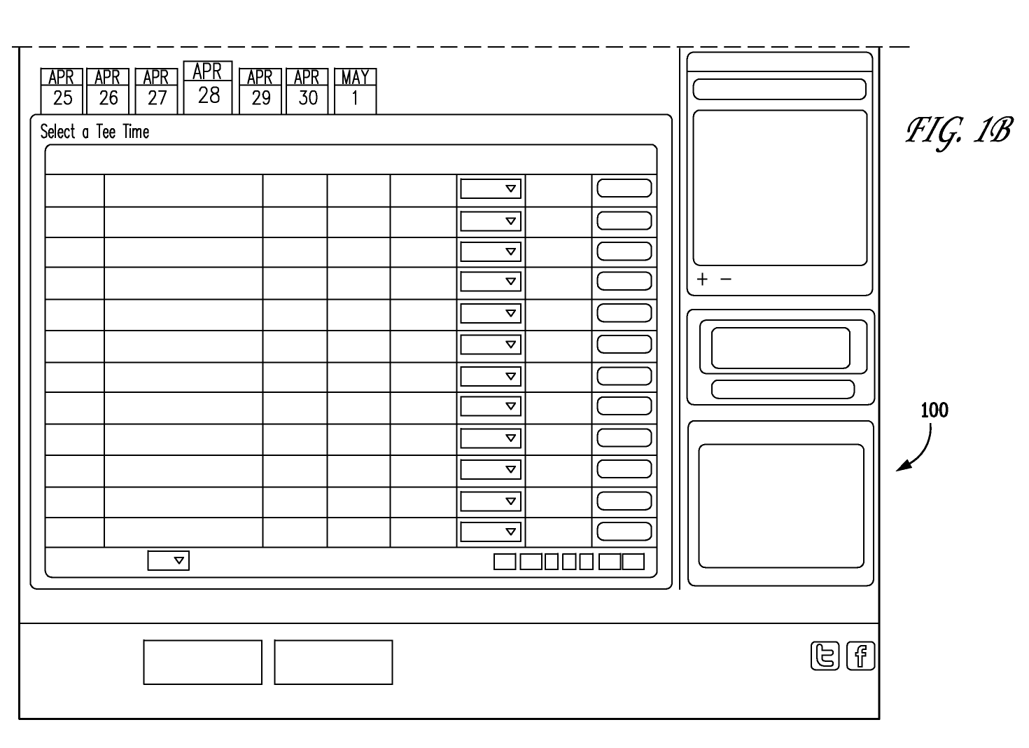

FIG. 2 illustrates control bar 200 of a charitable donation website, tee time reservation website 100. Control bar 200 has links, including a charity registration link 210, supporter registration link 220, and golfer account management link 230. Golfers, charities, and sponsors may use the links on control bar 200 to access account registration, creation, log in, and management utilities (not shown). In some embodiments, golfers may create an account, such as a password-protected account. Accounts may include identity and payment information, and a golfer profile including information about preferences regarding courses, tee times, green fees, charities, and may further include alerts and notifications regarding the availability of tee times and charitable opportunities matching the golfer profile.

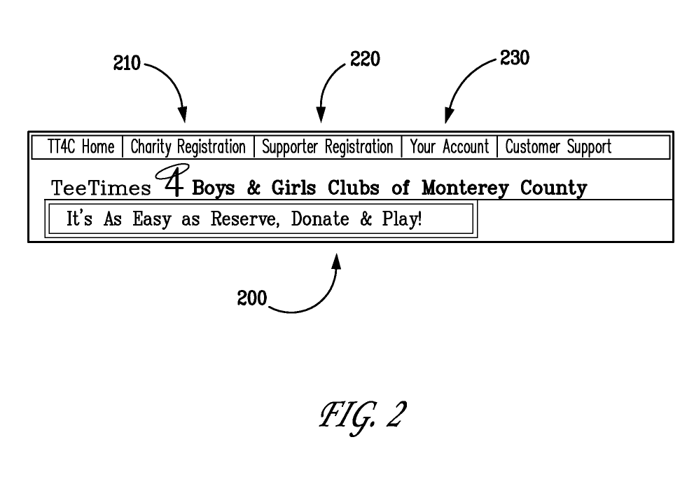

In various embodiments, the charitable donation website may include a charity tee time search functionality which a player may use to conduct a search for a tee time at a suitable course. Embodiments of charity tee time search functionalities may include various filters to refine a search based on desired region, course, and date of play. FIG. 3 illustrates charitable tee time search form 300 of discount with donation website 100. Charitable tee time search form 300 may have search filters including an area search filter 310, a course filter 320, and date range filters 330. In various embodiments, search filters may include filters for zip code, difficulty, handicap, price, date and time, club amenities, sponsoring companies, participating or eligible charities, and desired group size, as well as others. Embodiments of the charitable donation website, such as the discount with donation website 100, may provide an online form for golfers to enter a desired charity donation amount and execute an associated transaction.

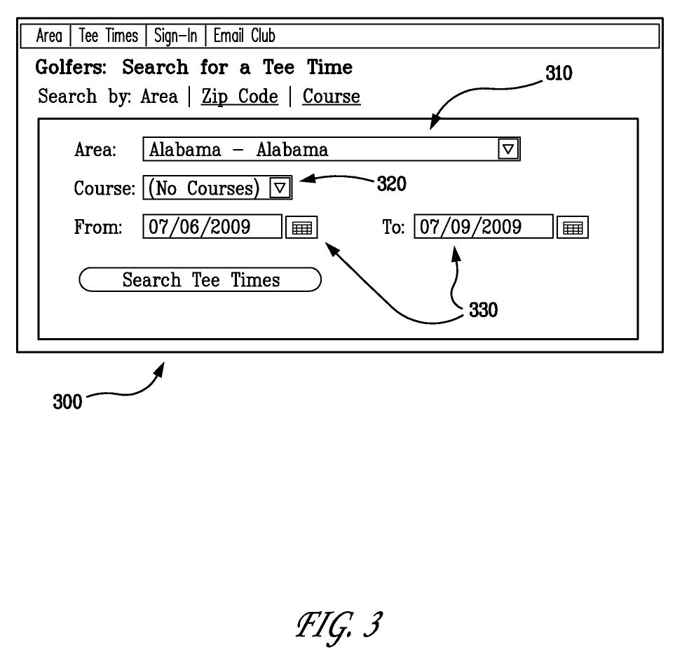

In various embodiments, a discount with donation website 100 may also include a search form for golfers to find charities which the golfer desires to support. Some embodiments may also provide a search form for golfers to find sponsors, such as corporate sponsors, that support participating charities as a part of the discount with donation system. A golfer may use the charity search form to find charitable causes and to check if a corresponding charitable organization is eligible to receive donations in conjunction with tee time reservations at certain courses. Embodiments of search forms may provide event filter functionality to allow a golfer to search for a particular golf event. FIG. 4 illustrates a search form 400 of discount with donation website 100. Search form 400 may provide a nonprofit search filter 410, a supporter search filter 420, and an event search filter 430.

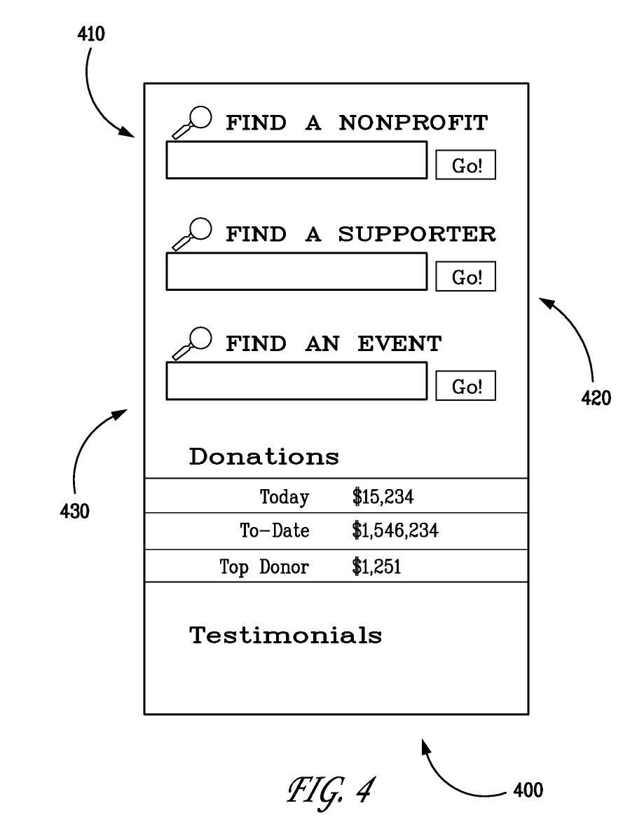

In some embodiments, the discount with donation website may feature particular charities, for example charities in support of causes of contemporary or current interest. For example, specific organizations may be featured in the wake of particular occurrences such as natural disasters, military strife, earthquakes, hurricanes, floods, attacks, famine, etc. FIG. 5 illustrates an exemplary charity content 500, featured on discount with donation website 100.

Embodiments of the discount with donation website may have web and social media utilities, for example to allow member charities to promote events, tee time reservations, send integrated text messaging, launch donation campaigns, create calendars of events, highlight matching corporate sponsor partner donations, and other social networking, electronic media, and others. In some embodiments, charities may create customized web pages within the domain of the discount with donation website, and feature links to the charity home page. In various embodiments, member charities' customized web pages may be assigned a unique URL incorporating the charity name, for example for search engine optimization.

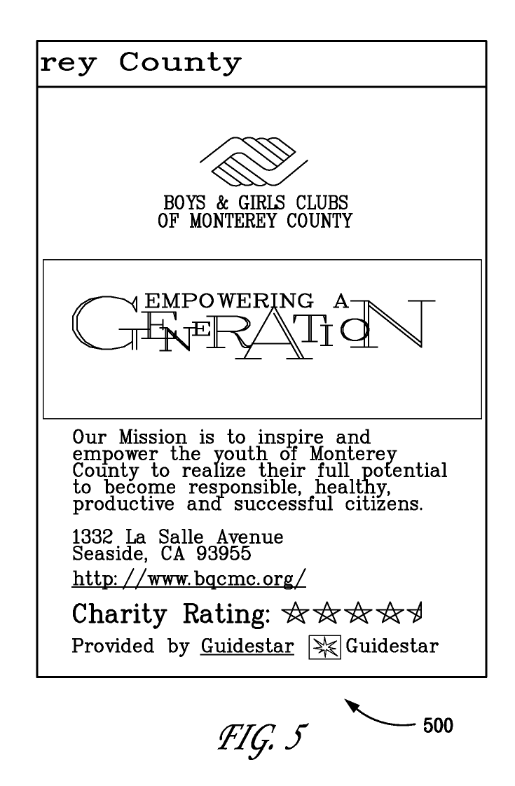

Sponsors may feature charitable donation content on embodiments of the charitable tee time website, for example as a part of a marketing or promotion campaign to increase exposure of a product or service. For example, a corporate sponsor may feature matching charitable donation content. FIG. 6 illustrates matching charitable donation content 600, of discount with donation website 100, from a member corporate sponsor.

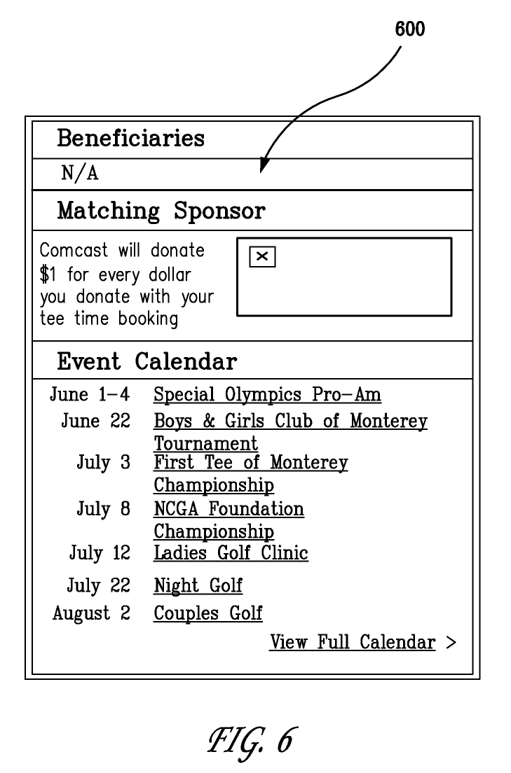

In some embodiments, sponsors may offer business promotions on the website, such as products, services, sales, special offers, contest promotions, etc. Sponsors may offer promotions in conjunction with golfer charitable giving, for example in the form of discounts, rebates, credits, or other incentives in association with member golfer donations. FIG. 7 illustrates a sponsor promotion 700 of discount with donation website 100.

Embodiments of the present technology include novel methods for facilitating charitable donations. In some embodiments, the method may be initiated by collecting an inventory of fixed price goods or services offers and reselling them to charitable donors. Some embodiments of the present methods include collecting an inventory of perishable goods or services. Charities, such as local nonprofits (e.g., schools and churches), large charities, and national or international charities may use embodiments of the present method to generate exposure for specific events or fundraising campaigns.

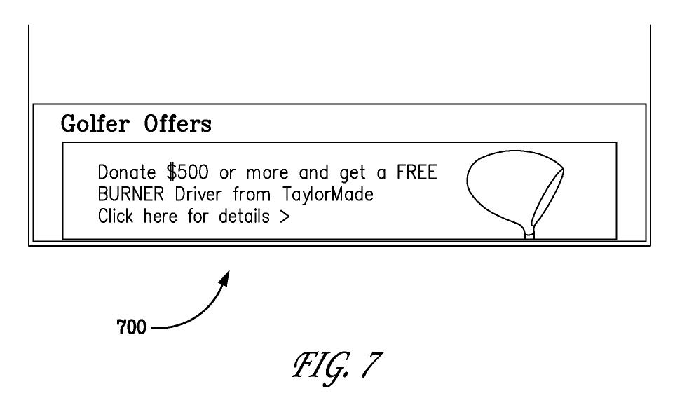

FIG. 8 illustrates an embodiment of the inventive method, method 800. In method 800, a user of the method collects 810 an inventory of goods or services at a first price, and offers 820 the collected goods or services for sale to charitable donors at a second price. The first price may be a special price such as a wholesale or special charity price, and may be lower than the second price. The second price may be below a third price, such as an ordinary retail price for the goods or service. In conjunction with selling 830 the collected goods or services at the second price to a charitable donor, the user may solicit 840 or require a charitable donation from the charitable donor in exchange for the charitable donor's purchase of the goods or services at the second price. The user may then facilitate 860 a charitable donation transaction to the selected charity. In some embodiments, the second price plus the charitable donation may be less than the third price. In this manner, the charitable donor may obtain the goods or service at a discount from the third price.

In some embodiments, the user may solicit and receive 850 a designation of a specific charity to receive the donation from the charitable donor. The user of the method may optionally collect 870 a transaction fee for each donation. The transaction fee collected by the user may be a fixed fee, a percentage of the charitable donation, or a combination of both. In some embodiments, the user may optionally provide 880 donation reports to the donors or to the organizations providing the goods and services at the first price, for example for tax accounting purposes. In some embodiments, collection and distribution of donations may be managed by a trusted third party. Donations may be reported and processed for payment to the charity on a periodic basis, such as on a weekly or monthly basis.

Embodiments of the present inventive methods may be conducted by an operator of the herein-disclosed discount with donation system to facilitate charitable giving. An exemplary embodiment of the method involves the collection of an inventory of tee times at a price less than retail. In some embodiments, tee times may be reserved in bulk, such as from tee time reservation networks or from golf courses at a reduced green fee rate, for offer to golfers, for example using an embodiment of the herein-disclosed discount with donation website. Exemplary methods may include offering the tee times for resale at a higher resale rate, soliciting a charitable donation in exchange for the opportunity to reserve the tee time at the resale rate, and facilitating the charitable donation.

In some embodiments of the present method, a golfer may offer charitable donations in a flat amount, for example $10, or as a percentage of a green fee. In various embodiments, depending on the charity and golf course, a donation may be for the same amount, more than, or less than any green fee discount received. For example, a golfer may realize a savings from the standard retail green fee rate, and all or some portion of the savings may be processed directly as a donation to the charity selected by the golfer.

In one exemplary embodiment, a player may donate $10 to a charity for a $5 discount from retail on green fees. In another embodiment, a player may provide a donation of 50% of the green fee for a corresponding 50% discount of the total green fee. In another embodiment, a player may provide a $10 donation to charity for a $20 reduction in green fees. Therefore, in some embodiments, the golfer's total cost of the donation, processing and the special charity green fee may be less than the regular green fee rate.

In some embodiments sponsors, such as corporate sponsors of the herein-disclosed discount with donation system, may offer corporate donations, such as matching donations, as a part of the golfer donations. Corporate member donations may be based on the amount donated by the player, or rounds reserved by the player. Sponsor donations may be specific to a charity or generally applicable to charitable green fee purchases. Sponsor donations may be collected at the time of reservation, or later. Additional golfer donations may be solicited at the time of reservation and donation check-out.

Another component of the present invention is an Internet-based, real to virtual golf game that uses results of actual (“real”) rounds of golf to allow individuals or groups of players to participate in competitions against each other or together in tournaments. The real to virtual golf game allows players to invite other players to participate in a real to virtual game of golf whereby the participants actually play a real game and then use the results of the real activity for scoring the virtual golf game and to compete virtually. In some embodiments, players do not have to be at the same venue at the same time to participate and compete. Participants in different locations may play a golf game together, or engage in another activity.

Embodiments of the real to virtual golf game may be used by organizations to facilitate internal golf tournaments. For example, members of a school, company, department, fraternity or sorority, club, fraternal society, alumni organization, or other groups may create golf competitions using embodiments of the invention. Additionally, golf associations, clubs and social groups may create a competition format to drive the growth of the organization.

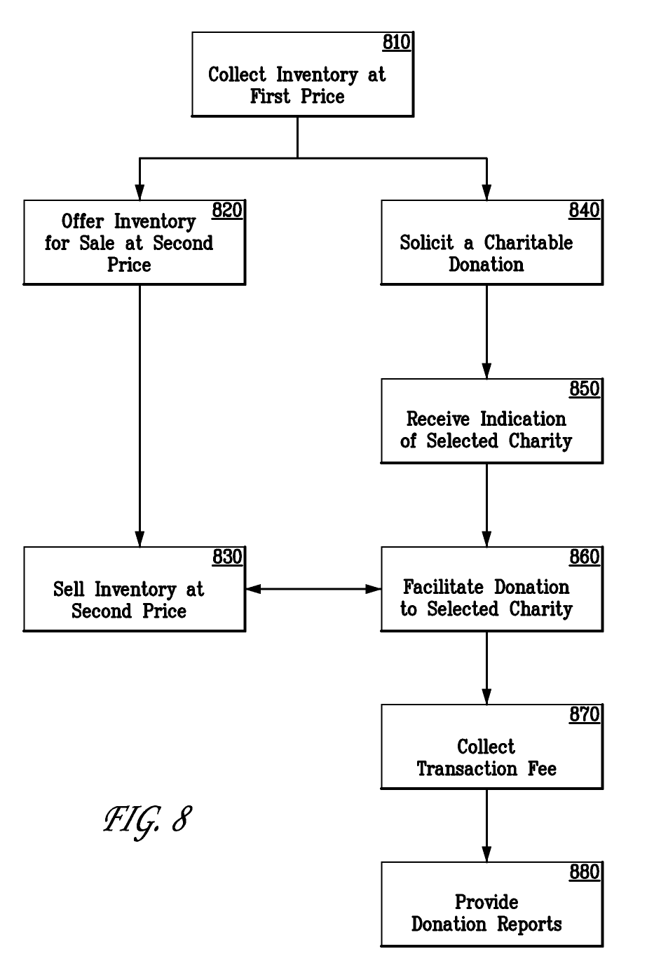

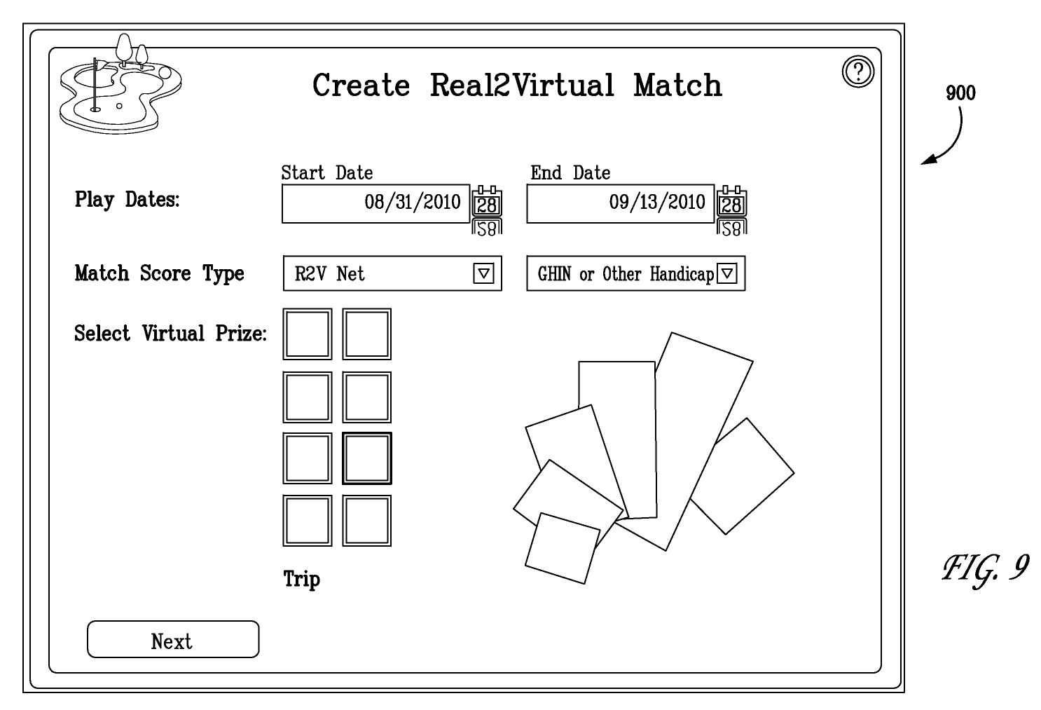

The real to virtual golf game may be hosted on a real to virtual golf game website, such as a computer- or mobile-optimized website. The real to virtual golf game website may provide an interface 900 (see FIG. 9) to allow players to sign up for a real to virtual golf game. Another interface 1000 may allow players to invite other players as shown in FIG. 10). In various embodiments, a real to virtual golf game website may be linked to and from, or featured by, a discount with donation website, such as is disclosed herein.

Embodiments of a real to virtual golf game may allow players to select a particular game format, select a particular player handicap requirement, select virtual prizes to compete for, search for and send invitations to other players, specify playing windows of time during which the players may play their actual golf rounds, and upload results of the actual rounds of golf for scoring. In various embodiments, actual play or participation results may be recorded, and results are compared. Optionally, players may be invited to play in further, more advanced tournaments based on their play results. Some embodiments of the real to virtual golf game may link to a website associated with the present discount with donation website.

In various embodiments of the present invention, a user may elect to become an organizer and organize an event, such as a match (two players one-to-one), team (group one-to-one or one-to-many), or event (three or more players together), and invite other players to participate by playing on any real golf course, during any specified period. The match, team or event competition results will be a selected format based on the gross (actual) score, and net (gross score less the player's course handicap) score. The score may be the score for the total round (i.e. 18 holes) played or hole by hole. The match, team or event may include any type of golf play format with any number of individual or team players and teams, including but not limited to Four Ball, Scramble, Foursomes, Chapman, Callaway with medal play, Stableford, or hole by hole scoring.

Organizers may use social media tools to locate a buddy or member already registered with the real to virtual golf game, or to invite a friend to join a real to virtual golf game network to play as a partner. In various embodiments, an organizer may send an invitation to other players to participate in a match or event using email, Internet, social networks and mobile media communication. Embodiments of the real to virtual golf game may use online communication such as Internet, email, social and mobile media platforms to facilitate communication between participants before, during, and after a game.

Some embodiments of the real to virtual golf game provide online and mobile interfaces, applications, and tools for players to participate in an online community by sharing content and communicating with other players. Embodiments of the real to virtual golf game website may include web-based real to virtual golf tools that allow users to: create and invite participants; accept invitations and register for an event; allow invitees to invite others to play; to post play results; post images, videos, and messages after the event or in real-time; calculate results and reward virtual and real prizes; process charitable donations; and access historical results.

In various embodiments, the real to virtual golf game may be provided for an Internet-enabled gaming console, such as a Nintendo®, Sony®, Microsoft®, or other console. In further embodiments, the real to virtual golf game may be provided as a mobile application, such as a downloadable application for an Internet-enabled personal mobile device or smartphone, for example as an iPhone® or Android® app. In some embodiments of the real to virtual golf game, a golf course may provide update terminals to allow players to access the real to virtual golf game and enter results while on site, such as in a clubhouse or integrated into a golf cart.

Various embodiments of the real to virtual golf game include a mobile real to virtual golf application that may be downloaded, for example from the real to virtual golf game website. The mobile real to virtual golf application may allow players to provide updates regarding their play during or immediately after a round of golf, for example to facilitate a tournament during the course of a particular day. Mobile real to virtual golf applications may allow players to communicate with other players during a real round, for example to ask for advice about a shot, club, hole, course, or to post results, such as after a hole, round, or shot. In various embodiments, mobile real to virtual golf applications may allow a player to post video, audio, or photos. Using a mobile real to virtual golf application, a player's real to virtual team may monitor as spectators another player's play during a round. Players may access the real to virtual golf game website through a mobile real to virtual golf application to check the results of other tournaments or other players during their own rounds, in order to create the pressure and intensity of actual heads-up match play.

While or after the players play their actual rounds of golf, they may upload their actual results to the real to virtual golf game, for example using the Internet. The real to virtual golf game may then calculate results for the real to virtual golf game. Embodiments of the real to virtual golf game may record and maintain a player's score associated with her or his profile, and in some embodiments, may provide rankings and handicaps, chart trends and streaks, and help a player to track and quantify the effects of changes in technique, equipment, coaching, or stroke.

In various embodiments, prizes may be awarded. Prizes may be selected by the organizer or be provided as part of the real to virtual golf game. Prizes may include any or several of the following: recognition with the real to virtual golf game community, such as a featured profile; club product discounts; golf brand product discounts; brand and travel prizes; and others. In some embodiments, prizes may be virtual (not real). Virtual prizes may include a donation to charity on a winner's behalf, a promotional offer, an entry into a sweepstakes, or others. Virtual prizes may be offered free or for a fee, depending on the brand product and participant offer.

Sponsors, such as corporate sponsors, may register with the real to virtual golf game website to sponsor particular competitions and offer prizes as part of a promotion. Sponsors of the real to virtual golf game may be sponsors of the herein-disclosed discount with donation system, or other sponsors. Registered sponsors may create matches, competitions, and events, for which players may register to compete. Sponsors may organize events of general admission, or invitational events. Sponsors may create events for which players must qualify, for example based on past play performance.

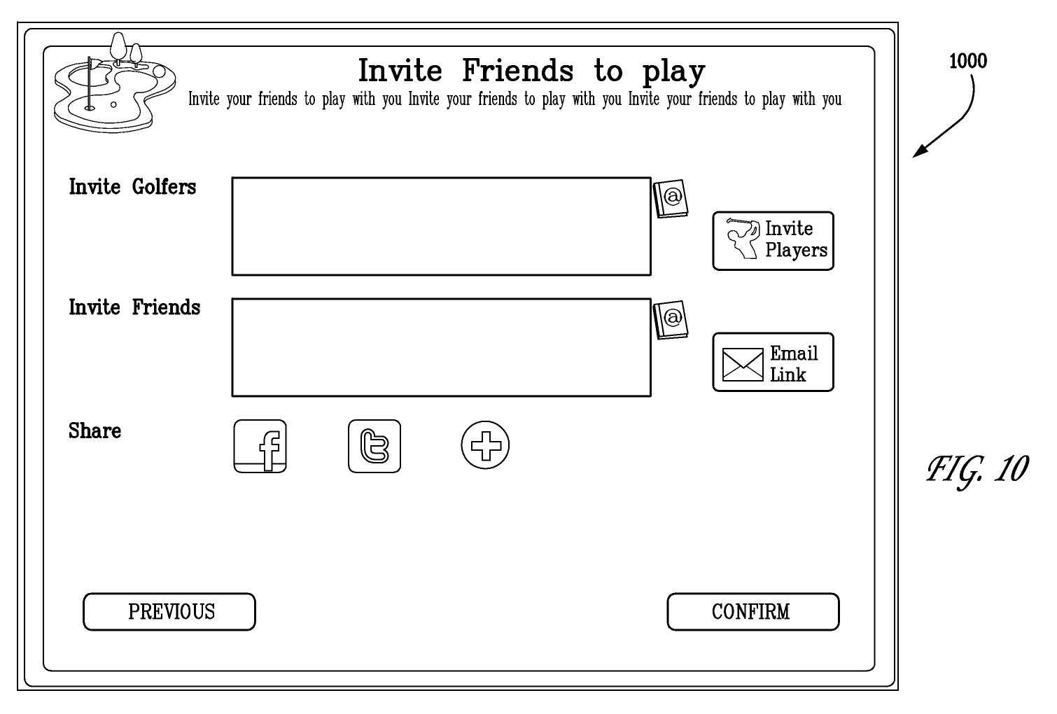

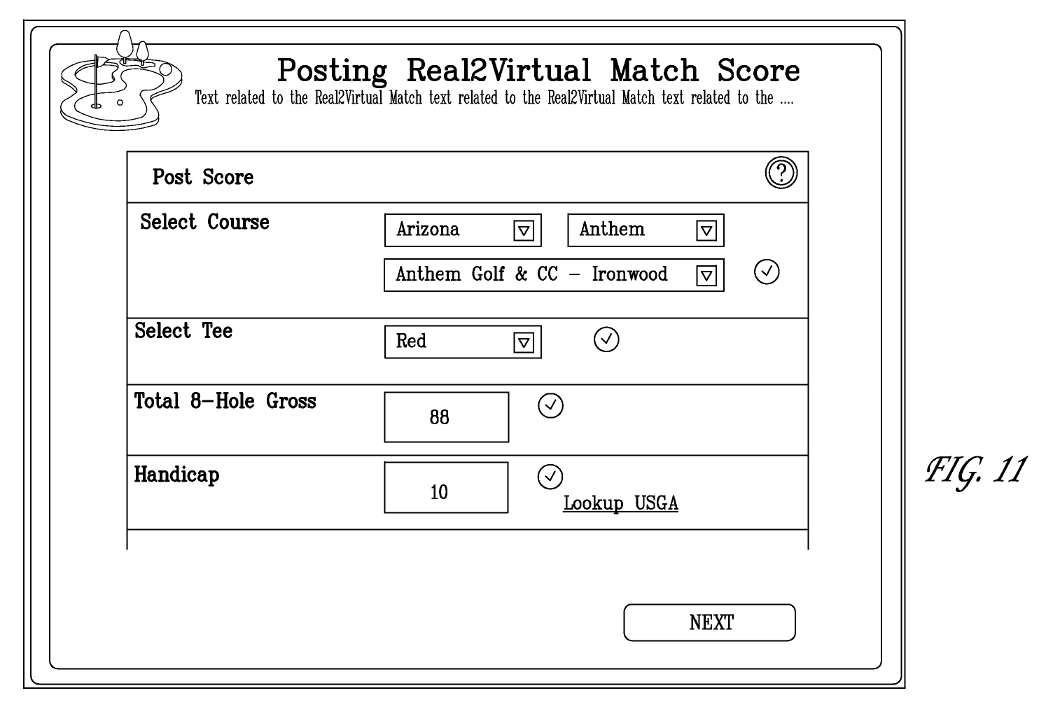

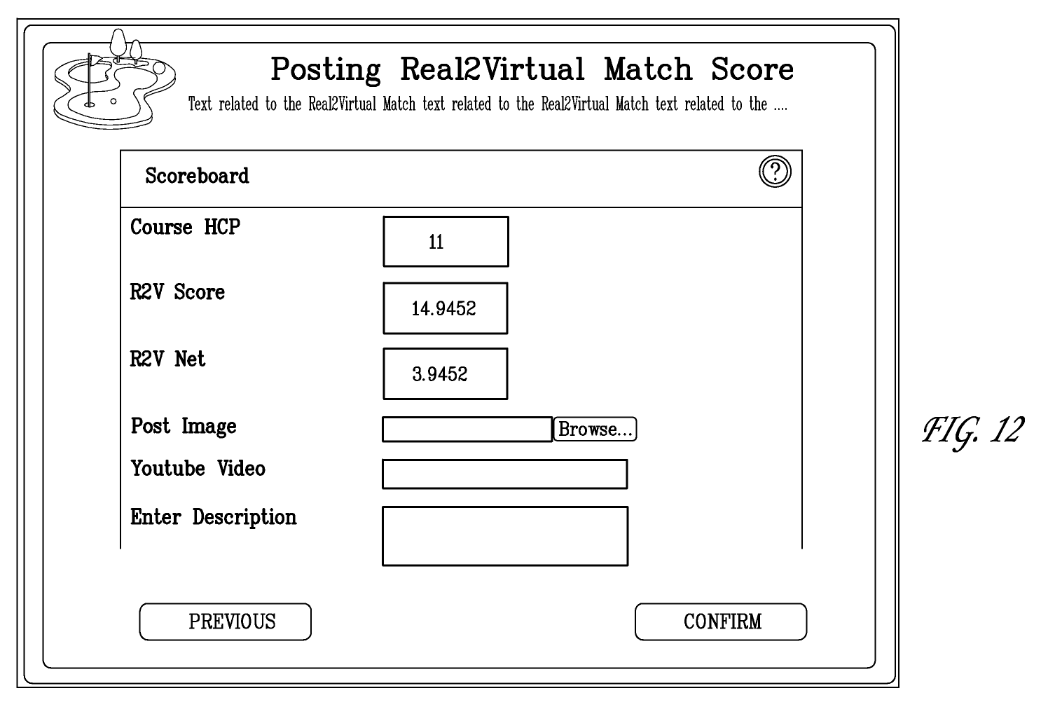

Players in the disclosed real to virtual golf game may post actual score results to the real to virtual golf game website using interfaces such as those illustrated in FIG. 11 and FIG. 12. Players may also utilize an online scorecard as illustrated in FIG. 13. Online scorecard 101 is an Internet-based form by which players in a real to virtual golf game may enter and upload their scores from actual rounds of golf for scoring in a real to virtual golf game. A player's or team's actual score for a round of golf (total or hole-by-hole) may be entered using any Internet-enabled device, such as a mobile device, a personal computer, laptop, an at-course score entry terminal, an on-course golf cart terminals, or other means.

In some embodiments, such as in match play, results may be based on the actual total strokes played by a golfer in a round of golf (including hole-by-hole score if required) at a specific golf course from a specific set of tees. In various embodiments, the result may be based on the actual total score adjusted by degree of difficulty for the specific course played, for example based on the USGA Course Rating and Slope information, or specific course information approved and provided by a governing golf association. In some embodiments, results may be adjusted based on additional factors, such as weather or recent player results. In various embodiments of the real to virtual golf game, actual raw play results may be further adjusted based on player skill level, body mass index, gender, age, experience, or other factors. In some embodiments, hole-by-hole and round winner results for a real to virtual game may be based on the player's actual gross or net score on a hole in relationship to par for the hole and compared to an opposing player's score.

For example, in some embodiments of the disclosed real to virtual golf game, a player may earn a real to virtual gross score result (“R2V Gross”), which may be the actual total strokes played adjusted for the course difficulty, or a real to virtual net score result (“R2V Net”), for example the gross score minus the player's handicap, for the course played, based on the USGA Course Handicap. A match play result may be the actual gross or net score on a hole, (net score is gross score minus the player's course handicap strokes on a specific hole based on the hole handicap), in relationship to par on the hole (“R2V Hole”) and then compared to the opposing player's score result on the hole, for example to determine a hole-by-hole and aggregate holes per round winner.

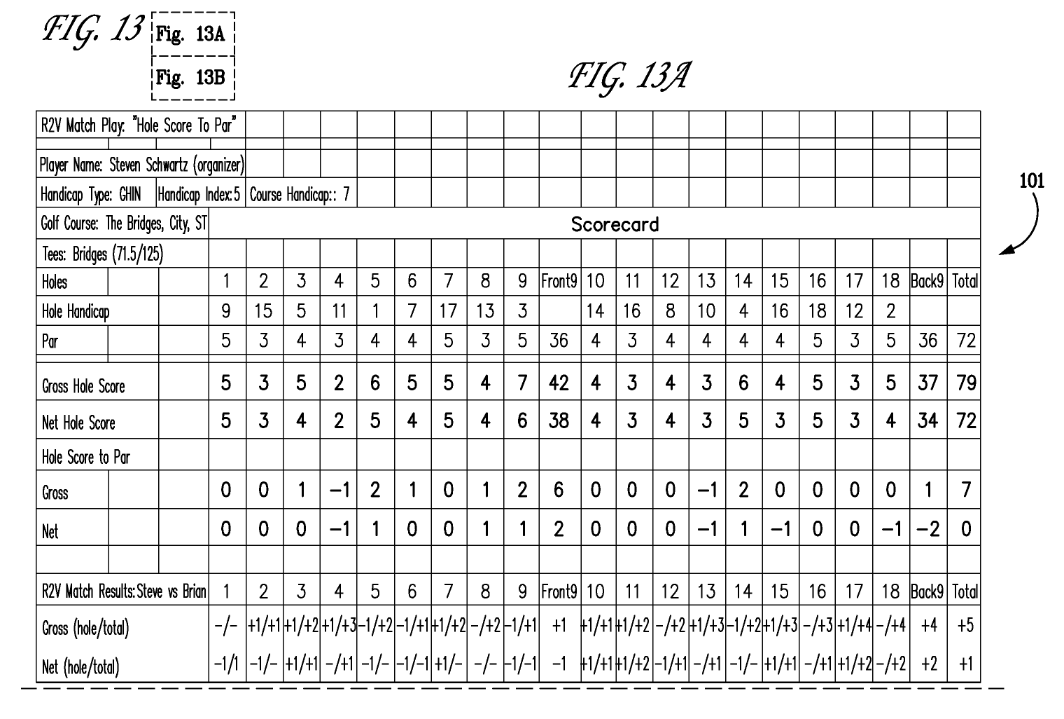

FIG. 14 illustrates an exemplary online organizer scorecard 102 for an organizer in an embodiment of the real to virtual golf game. Online organizer scorecard 102 is an Internet-based form by which an organizer in a real to virtual golf game may enter and upload his or her scores from actual rounds of golf for scoring in the real to virtual golf game. Online organizer scorecard 102 is an embodiment of a match play hole score to par game scorecard, which allows players (individual and team) to play different golf courses with different holes and compare the playing results on a hole-by-hole or group of holes (i.e. 9-holes, 18-holes) basis, to determine a winner of a match between the players or teams. In a match play hole score to par game, a player plays golf on a golf course and records actual hole score (gross hole score 112) for all holes played. In some embodiments, a golf course may have holes organized with a par 132 rating and may include a hole handicap 122. The players' gross hole score 112 is compared to the hole par 132. The difference is the gross hole score to par 142. The net hole score 152 is calculated from the gross hole score 112 less handicap strokes allocated for a specific hole based on the players' course handicap 172 and the golf course specific hole handicap 122. The net hole score 152 is compared to the par 132 on the hole. The difference is the net hole score to par 162. The gross hole score to par 142 and net hole score to par 162 is then compared between each player or team to determine a hole-by-hole winner.

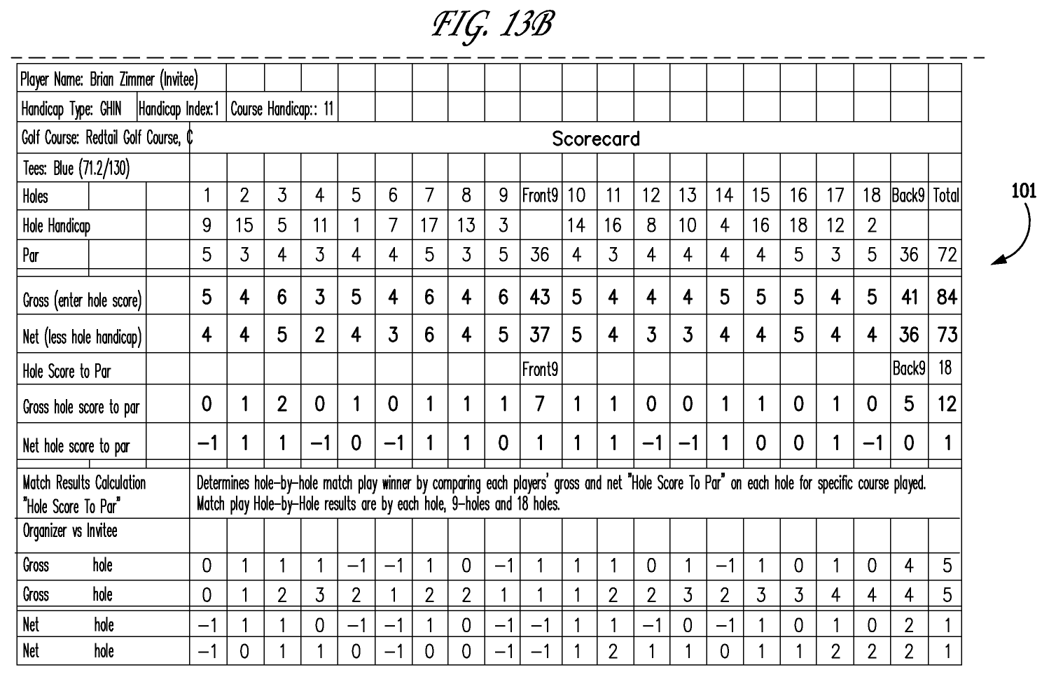

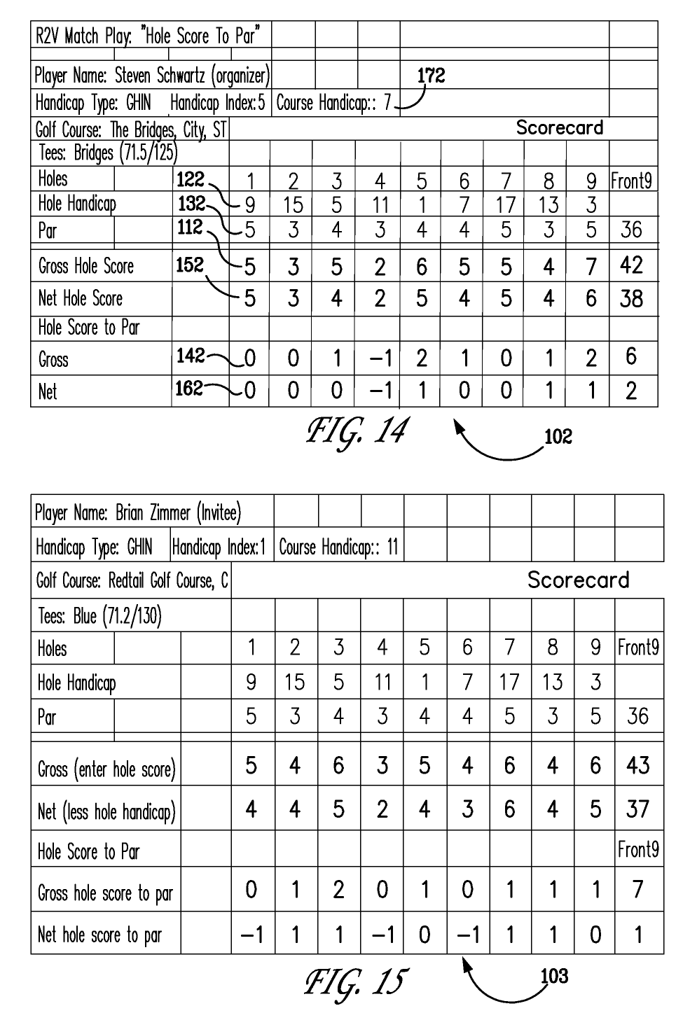

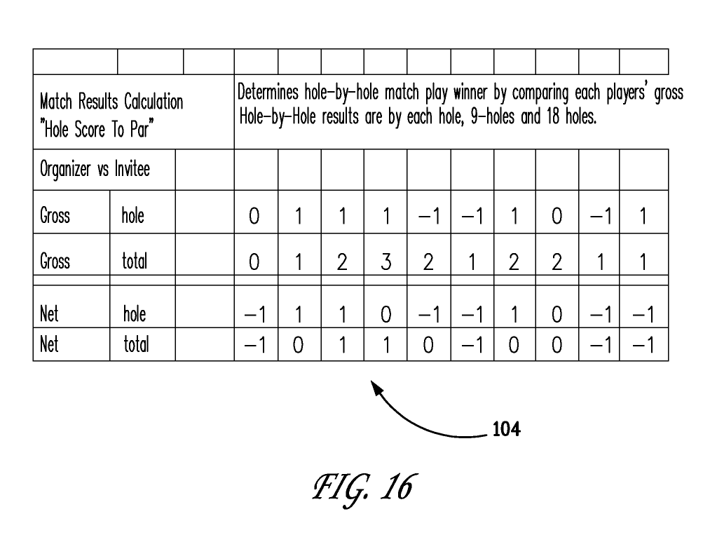

An exemplary online opponent's scorecard 103 is illustrated in FIG. 15. Online opponent's (invitee) scorecard 103 is an Internet-based form by which an opponent in a real to virtual golf game may enter and upload his or her scores from actual rounds of golf for scoring in a real to virtual golf game. FIG. 16 illustrates an online comparative scorecard 104 showing the scores of the organizer illustrated in FIG. 14 along with the scores of the opponent from FIG. 15. Online comparative scorecard 104 is an Internet-based form by which players in a real to virtual golf game may compare their scores for scoring in a real to virtual golf game. Match results may then be reported through an interface such as that shown in FIG. 17. In various embodiments, a particular result may be used to calculate and rank an individual player's or team's score for a round of golf when play is completed on any golf course on the same or different days. Embodiments of the real to virtual golf game may then compare and rank the player's or team's results to create competition results based on the type of event scoring and handicap requirements selected by the match or event organizer.

It will be recognized by those skilled in the art that various embodiments of the real to virtual method may allow people remote from each other to compete in various activities. While the bulk of the disclosure herein is made with reference to a golf game, the method for allowing remote competition may be extended to any activity chosen by the participants. The activity may be for example a sport, a game, or an activity defined by the participants.

A further component of the present invention is a virtual golf tee containing a message, much like a fortune cookie (“virtual tee”). A virtual tee may provide nonprofits, golfers, courses, promoters, and brands with a product that links these groups through online systems to increase charitable donations. Virtual tees may be integrated with the disclosed real to virtual golf game and the discount with donation system. For example, virtual tees may be featured in the real to virtual golf game as rewards, prizes, or random events. In the context of the discount with donation system, registered users may send virtual tees to other users, corporate sponsors, charities, or courses may send virtual tees to golfers, and golfers may earn virtual tees based on donations.

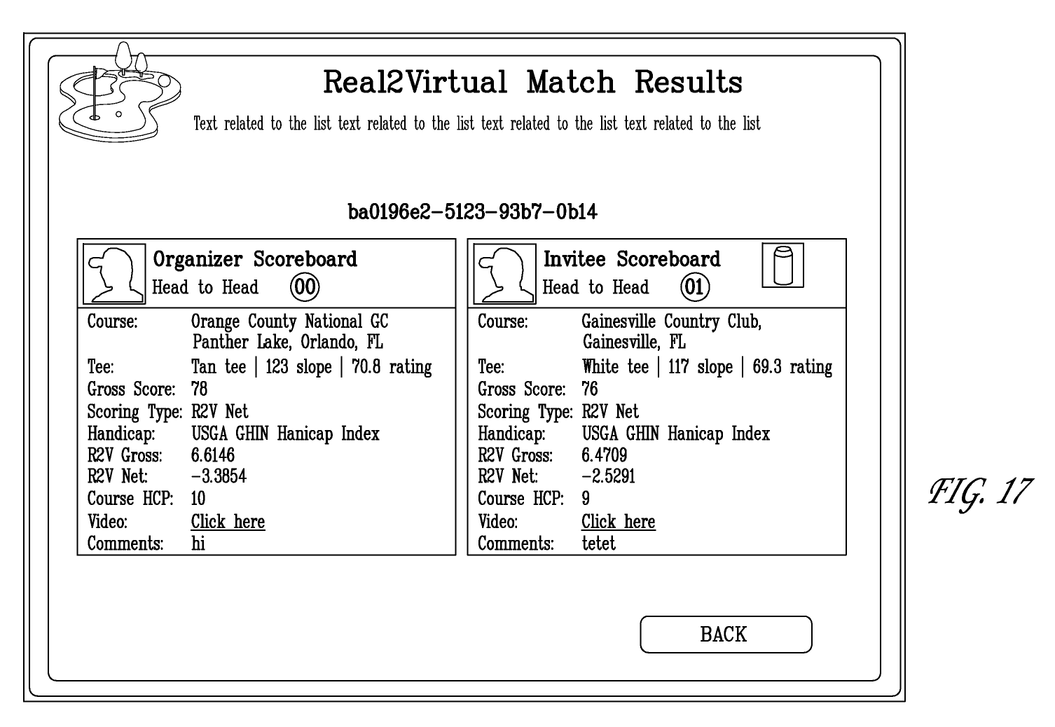

The virtual tee may be an electronic or digital image of a golf tee as depicted in FIG. 18, which illustrates an exemplary embodiment of a virtual tee 105. The virtual tee 105 may be a digital image displayed on a computer monitor or a mobile device, or printed out on a flyer or sheet. In some embodiments, a virtual tee may be depicted as any other product where the message is revealed when an action is taken on the screen. Virtual tees may “contain” a virtual note, message, or action.

Virtual tees may have dimensions similar to conventional physical golf tees as are known in the art. Exemplary virtual tees may resemble a conventional golf tee with a hollow shaft that when “broken open” presents a message coming out of the golf tee. It should be noted that many other mechanisms for delivering a message associated with the tee will be apparent to those skilled in the art. However, delivering an image of the tee breaking as if on impact from a golf club furthers the simulation of a golf game.

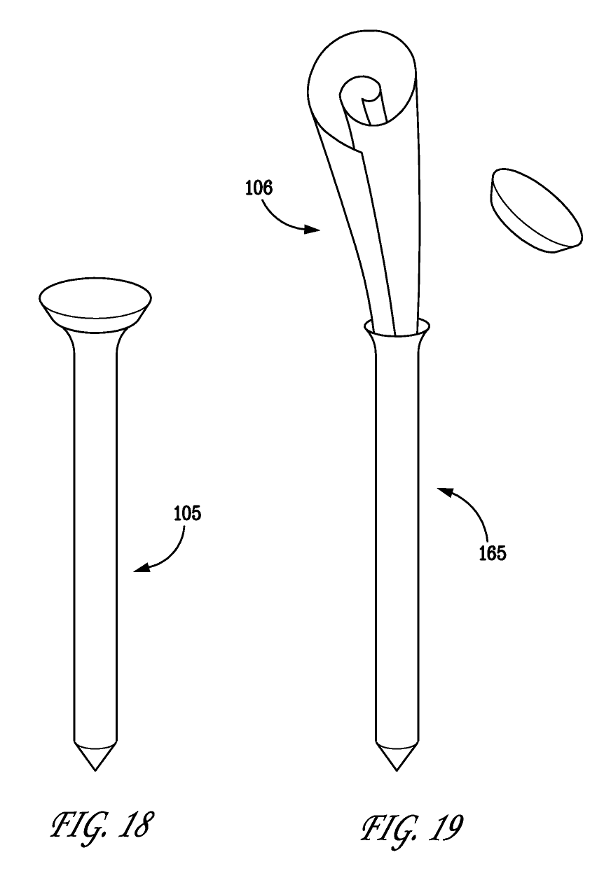

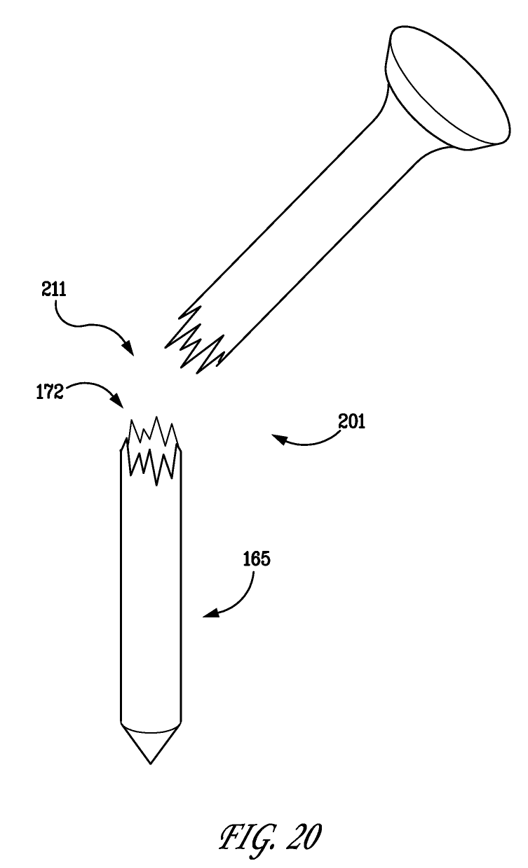

FIG. 19 illustrates virtual tee 109 showing virtual message 106 partially within hollow shaft 165. FIG. 20 illustrates a “broken open” virtual tee according to the present invention, fracture virtual tee 201. Virtual tee 201 is depicted as having a broken open area 211 exposing a cavity 172 which might contain the virtual message.

In some embodiments, when a virtual tee is broken open, it may present an image of a paper message coming out of the virtual tee (like a message from a fortune cookie) to reveal a message. In an online game embodiment (golf or other), a user may “hit a shot” via an input device such as a mouse, keyboard manipulation or verbal command and the virtual tee may break open upon hitting the shot or after the shot. A virtual tee message may then be displayed on the user's screen. Users may buy or be given additional virtual tees to provide additional golf shots or other incentives based on game objectives.

Virtual tees may be sent from a sender to a recipient, and may be broken open (activated) by the recipient, for example by clicking on an image of the virtual golf tee as it appears on the recipient's computer device, such as a PC, laptop, or mobile device. In some embodiments, a virtual tee may be sent by a sender to a recipient via email. The virtual tee may be implemented on the Internet with online games, social networks, viral marketing programs or tied to incentive programs or promotional marketing programs.

In some embodiments, virtual tees may include information or invitations to events, prizes, coupons, and other product, service or company promotions. In various embodiments, a message may contain a product or service discount offer, website URL, sweepstakes code and entry, game code or piece, trivia or a unique code that identifies a unique entry in a specific sweepstakes to win a prize. The message may optionally include “call to purchase” offers redeemable online, or in some embodiments, directly at the course where a player is playing. Instant win offers may be provided by golf courses and from corporate sponsors. In some embodiments, a virtual tee may contain a unique message that identifies a specific promotional offer from a specific brand. In various embodiments, a virtual tee may include a supplemental message from external business or nonprofit sponsor(s) which could include additional offerings or messages.

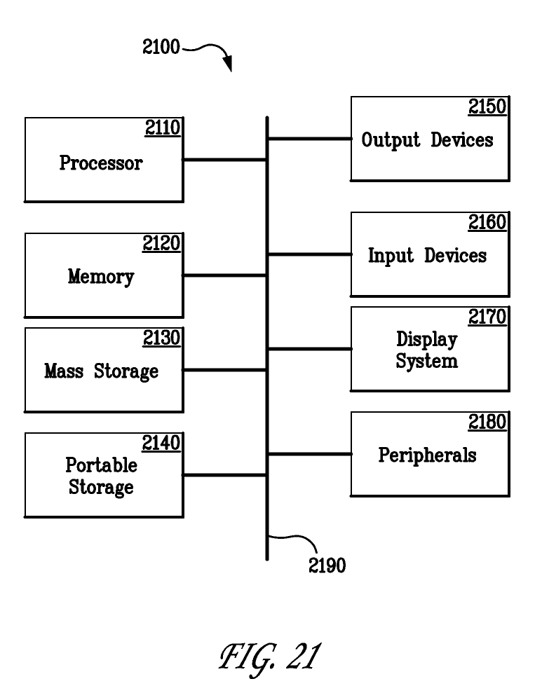

FIG. 21 illustrates an exemplary computing system 2100 that may be used to implement various embodiments of the present technology. The computing system 2100 includes one or more processors 2110 and main memory 2120. Main memory 2120 stores, in part, instructions and data for execution by processor 2110. Main memory 2120 can store the executable code when in operation. The computing system 2100 may further include a mass storage device 2130, portable storage medium drive(s) 2140, output devices 2150, user input devices 2160, a graphics display 2170, and peripheral device(s) 2180.

The components shown in FIG. 21 are depicted as being connected via a single bus 2190. The components may be connected through one or more data transport means. The processor 2110 and the main memory 2120 may be connected via a local microprocessor bus, and the mass storage device 2130, the peripheral devices 2180, the portable storage medium drive(s) 2140, and display system 2170 may be connected via one or more input/output (I/O) buses.

The mass storage device 2130, which may be implemented with a magnetic disk drive or an optical disk drive, is a non-volatile storage device for storing data and instructions for use by the processor 2110. The mass storage device 2130 can store the system software for implementing embodiments of the present invention for purposes of loading that software into the main memory 2120.

The portable storage device 2140 operates in conjunction with a portable non-volatile storage medium, such as a floppy disk, compact disk, digital video disc, or USB storage device, to input and output data and code to and from the computer system 2100 of FIG. 21. The system software for implementing embodiments of the present invention may be stored on such a portable medium and input to the computer system 2100 via the portable storage device 2140.

The input devices 2160 provide a portion of a user interface. The input devices 2160 may include an alpha-numeric keypad, such as a keyboard, for inputting alpha-numeric and other information, or a pointing device, such as a mouse, a trackball, stylus, or cursor direction keys. Additionally, the computing system 2100 as shown in FIG. 21 includes the output devices 2150. Suitable output devices include speakers, printers, network interfaces, and monitors.

The display system 2170 may include a liquid crystal display (LCD) or other suitable display device. The display system 2170 processes information it receives for output to the display device.

The peripheral device(s) 2180 may include any type of computer support device to add additional functionality to the computer system. The peripheral device(s) 2180 may include a modem or a router.

The components contained in the computer system 2100 of FIG. 21 are those typically found in computer systems that may be suitable for use with embodiments of the present invention and are intended to represent a broad category of such computer components that are well known in the art. Thus, the computer system 2100 of FIG. 21 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, webOS, Android, iPhone OS and other suitable operating systems.

Some of the above-described methods, steps, or functions may be defined by instructions that are stored on storage media (e.g., computer-readable media). The instructions may be retrieved and executed by the processor of the computer on which the system is resident. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

It should be noted that any hardware platform suitable for performing the processing described herein is suitable for use with the invention. The terms “computer-readable media” and “storage media” as used herein refer to any medium or media that participate in providing instructions to a CPU for execution. Such media may take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise an embodiment of a bus. Transmission media may also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, an EEPROM, a FLASHEPROM, any other memory chip or cartridge, a carrier wave, or any other medium from which a computer can read.

The embodiments discussed herein are illustrative of the present invention. As these embodiments of the present invention are described with reference to illustrations, various modifications or adaptations of the methods and or specific structures described can become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as can be included within the spirit and scope of the invention as defined by the present appended claims and otherwise appreciated by one of ordinary skill in the art.

What is claimed is:

1. A method of facilitating charitable donations, the method comprising:
collecting an inventory of goods or services offers, the offers being provided to a user at a discounted rate per good or service, the discounted rate per good or service being less than an original price;
making the offers available to a donor for purchase at an intermediate price, the intermediate price being less than the original price and more than the discounted rate per good or service;
requiring the donor to make a charitable donation in order to purchase an offer;
collecting a service fee from the donor in connection with either or both of the donor's purchase of the offer and the charitable donation; and
providing reports of charitable transactions to affected parties.

2. The method of claim 1, wherein the goods or services offers are golf tee times and golf events registration.

3. The method of claim 1, further comprising:
promoting a matching donation in connection with the donor's purchase of an offer, the matching donation representing a matching percentage of the charitable donation, the matching percentage being between 1% of the charitable donation and 400% of the charitable donation; and
matching the donation upon receiving the charitable donation.

4. The method of claim 1, further comprising:
promoting a matching donation in connection with a donor's purchase of an offer, the matching donation representing a matching percentage of the intermediate price, the matching percentage being between 1% of the intermediate price and 400% of the intermediate price; and
matching the donation upon receiving the charitable donation.

5. The method of claim 1, further comprising:
receiving goods or services search criteria from a donor; and
searching the inventory according to the goods or services search criteria to identify to the donor a good or service associated with the goods or services search criteria.

6. The method of claim 1, further comprising:
receiving charitable donation search criteria from a donor; and
searching a database of nonprofit organizations according to the charitable donation search criteria to identify for the donor a charitable donation opportunity associated with the charitable donation search criteria.

7. A method for providing an Internet-based golf game, the method comprising:
providing a real to virtual golf game website, the real to virtual golf game website having a user interface for an electronic real to virtual golf game having a set of rules;
receiving through the real to virtual golf game website a request to play the real to virtual golf game from a first player;
providing on the real to virtual golf game website an invitation tool to the first player, the invitation tool configured to send an invitation on the Internet to a second player to play the real to virtual golf game;
receiving through the real to virtual golf game website a request for the second player to play the real to virtual golf game;
receiving at the real to virtual golf game website first golf scores from the first player, the first golf scores being associated with an actual round of golf played by the first player at a first golf course at a first time;
receiving at the real to virtual golf game website second golf scores from the second player, the second golf scores being associated with an actual round of golf played by the second player at a second golf course at a second time; and
comparing the first golf scores and the second golf scores according to the set of rules to determine a winner.

8. The method of claim 7, wherein the first golf course is different from the second golf course.

9. The method of claim 7, wherein the first time is different from the second time.

10. The method of claim 7, wherein comparing the first golf scores and the second golf scores comprises weighting the first golf scores or the second golf scores according to a characteristic associated with the first golf course or the second golf course.

11. The method of claim 7, wherein the comparing the first golf scores and the second golf scores comprises weighting the first golf scores or the second golf scores according to the skill level of the first player or the skill level of the second player respectively.

12. The method of claim 7, wherein comparing the first golf scores and the second golf scores comprises comparing the first golf scores or the second golf scores of the first player and the second player respectively according to the actual gross or net score on a hole in relationship to par on the hole.

13. The method of claim 7, further comprising grouping players to compete as teams.

14. The method of claim 7, further comprising organizing multiple players in a tournament format.

15. The method of claim 7, further comprising providing a mechanism for players to invite other players to participate in a real to virtual golf game.

16. The method of claim 7, further comprising maintaining an account associated with a player, the account comprising a player profile reflecting the player's historical play results.

17. The method of claim 7, further comprising:
maintaining an account associated with a player, the account comprising a player profile reflecting the player's historical play results by player and between the first player and the second player; and
inviting the player to participate in a further real to virtual golf game based on the player profile.

18. The method of claim 7, further comprising awarding a prize to the winner.

19. The method of claim 7, further comprising awarding a prize to the winner, the prize comprising one or more of a product discount and a donation to charity on the winner's behalf.

20. An Internet-based system for facilitating a charitable donation from a donor in connection with the purchase of a good or service, the system comprising:
a website coupled to a website server;
an inventory search tool for searching an inventory of goods or services, the inventory search tool configured to identify a found good or service based on inventory search criteria provided to the website by the donor, the inventory search tool accessible to the donor through the website, the goods or services being available for purchase through the website at a first price, the first price being lower than a standard retail price;
a charity search tool configured to identify a found charity based on charity search criteria provided by the donor to the website, the charity search tool accessible to the donor through the website;
a charitable donation tool for executing the charitable donation to the found charity, the charitable donation tool accessible to the donor through the website; and
a purchase tool for executing a purchase of the found good or service at the first price in connection with executing the charitable donation, the purchase tool accessible to the donor through the website.

21. The system of claim 20, wherein the goods or services are golf tee times.

22. The system of claim 20, wherein the goods or services are golf tee times and wherein the inventory search criteria comprise one or more of a preferred date range, a preferred golf course, a preferred geographic region, and a preferred first price.

23. The system of claim 20, wherein the goods or services are golf tee times and wherein the charity search criteria comprise one or more of a preferred nonprofit organization, a preferred sponsor, and preferred event.

24. The system of claim 20, further comprising a donor account tool, the donor account becoming accessible to the donor upon the provision by the donor to the website of donor account credentials, the donor account tool enabling the donor to set preferences regarding one or more of goods or services, payment, first prices, charitable donations, and charities.

25. The system of claim 20, further comprising a charity sponsor tool configured to execute a matching donation from a sponsor to the found charity, the matching donation made upon the occasion of charitable donation, the matching donation representing a matching percentage of the charitable donation, the matching percentage being between 1% of the charitable donation and 400% of the charitable donation.

26. The system of claim 20, further comprising a charity sponsor tool configured to execute a matching donation from a sponsor to the found charity, the matching donation made upon the occasion of charitable donation, the matching donation representing a matching percentage of the first price, the matching percentage being between 1% of the first price and 400% of the first price.

27. A method of delivering a message comprising:
creating an image of a golf tee on a website supported by a server;
supplying a notification mechanism for a user to initiate retrieval of a message;
delivering the message upon execution of the triggering mechanism by the user.

28. The method of claim 27, wherein the notification mechanism comprises an image of a tee breaking.

29. The method of claim 27, wherein the message comprises marketing or promotional information.

30. The method of claim 27, wherein the message comprises one or more of an invitation, a coupon, a discount offer, a website URL, a contest code, a trivia question, and an instant win offer.
